(19) United States
(12) Patent Application Publication
(10) Pub. No.: US 2005/0047768 A1
(43) Pub. Date: Mar. 3, 2005

(54) Fluid heater with integral heater element ground connections

(75) Inventors: Karl-Heinz Kuebler, Grand Blanc, MI (US); Daryl G. Harris, Oxford, MI (US); Michael T. Amberg, Fenton, MI (US); David E. Duba SR., Shelbyville, IN (US)

Correspondence Address: J Gordon Lewis, 3000 University Drive, Auburn Hills, MI, 48325-2356, US

(73) Assignee: Valeo Electrical Systems, Inc., Auburn Hills, MI (US)

(21) Appl. No.: 10/653,005

(22) Filed: Aug. 29, 2003

(51) Int. Cl. H05B 3/78

(52) U.S. Cl. 392/493; 392/494; 219/202

(57) ABSTRACT

A heat source is disposed in a thermally conductive mass for imparting heat to the mass. Fluid in a flow path through the mass absorbs heat from the mass. One or more heater elements forming the heat source are disposed in direct contact with the mass. A ground plate connected to a ground terminal is fixedly connected to the heater elements, either on a portion of the heater elements extending exteriorly of the mass, on a portion of the heater elements disposed within the mass, or substantially all the ground plate insert molded in the mass on the heater elements. Alternately, the ground member is insert molded in the mass separate from the heater elements, but connects electrical heater elements to ground through the mass.

### BACKGROUND

This invention relates, in general, to fluid heater apparatus and, more particularly, to fluid heater apparatus which provides a heated wash fluid to a cleanable surface, and, still more specifically, to a heated wash fluid apparatus for a vehicle windshield wash system.

It is necessary in many diverse applications to quickly elevate the temperature of a fluid to a higher use temperature. For example, it is desirable to be able to provide instant hot water, for use in homes, offices and campers, as well as for industrial processes.

In cleaning applications, it is known that hot fluid removes dirt and other debris from a surface much better and much faster than colder fluids. One heated fluid application is a vehicle wash fluid system, such as a windshield wash system as well as vehicle wash systems applied to camera lenses, exterior lamps and lamp lenses, mirrors, etc. Vehicles are typically provided with at least one and usually multiple windshield washers which are used to clear the field of vision in a windshield or rear backlight.

Typically, a nozzle or spray device is provided adjacent to or as part of the windshield wiper to disperse a pattern of wash fluid onto the windshield prior to and during the wiping operation to improve the efficiency of the wiping operation so as to provide a clear field of vision for the driver or vehicle passengers. The wash fluid is typically stored in a reservoir in the engine compartment and is pumped through the spray device upon manual activation of a control actuator by the vehicle driver.

Since it is known that warm or heated fluid provides better cleaning efficiency than cold fluid, it is known to provide a heated wash fluid to a vehicle window spray device. Various wash fluid heating devices have been developed, but all typically utilize a heat exchanger design wherein a heat source is disposed in a body through which the wash fluid flows. The wash fluid picks up heat in the heat exchange body which elevates its temperature prior to dispersion through the spray nozzle onto a vehicle window.

To provide enhanced thermal conductivity for more efficient heat transfer from the heater elements to the fluid being heated, a fluid heater has been previously devised and assigned to the Assignee of the present invention in which one or more heater elements are mounted in and substantially encompassed by a thermally conductive mass or body. A fluid flow channel is formed in the body.

Heat generated by activation of the heater elements is transmitted to the thermal mass to elevate the temperature of the thermal mass. The heat of the thermal mass is in turn transmitted to the fluid flowing between an inlet and an outlet of the fluid flow channel to elevate the temperature of the fluid as it is discharged from the outlet.

In this prior construction, bores were formed by machining operations, i.e. milling or drilling, etc. in the thermal mass to receive the heater elements.

In the above-described fluid heater, the heater elements can be provided in a so-called “calrod” structure formed of a stainless steel outer sheath from one end of which a terminal projects. The terminal is electrically connected within the sheath to a Nichrome wire which generates heat when electric power is connected to the terminal. A ground connection is made the exterior sheaths of each of the heater elements typically by a ground plate welded to the sheaths adjacent to the terminals.

The ground plate was typically welded to the sheaths after the heater elements were mounted in the bores in the thermal mass. However, this structure involves additional manufacturing steps since the heater elements were first mounted in the bores in the thermal mass before the ground plate is affixed thereto in a separate process step.

Thus, it would be desirable to provide a fluid heater in which a ground connection to the heater elements can be made with fewer manufacturing process steps.

### SUMMARY

The present invention is a fluid heater apparatus, in one aspect of which, at least one or more heater elements are fixedly mounted in the mass.

In another aspect, the one or more heater elements are connected to electrical ground by a ground terminal which is fixedly mounted to the exterior sheath of each heater element in a position exteriorly of the mass, at least partially embedded in the mass, or substantially completely embedded in the mass.

In yet another aspect of the invention, the ground plate of the ground terminal is insert molded in the mass spaced from the heater elements. The ground terminal grounds the exterior sheaths of the heater elements through the intervening mass.

In another aspect, the present invention is a method of heating fluid comprising the steps of:

providing a thermally conductive mass having at least one fluid flow path extending therethrough;

mounting a heater means in the thermally conductive mass; and

coupling a ground terminal to the heater means, when at least a portion of the ground terminal is connected to the thermally conductive mass.

The method also includes the steps of forming the ground terminal with an exterior terminal end projecting from the mass, connecting a ground plate connected to the terminal leg, and mounting at least a portion of the ground plate in the mass.

The method also includes the step of insert mounting at least a portion of the ground plate in the mass.

The method also includes the step of mounting substantially all of the ground plate in the thermally conductive mass.

The method also includes the step of mounting at least substantially all of the ground plate in the mass.

The method also includes the step of fixedly mounting at least a portion of the ground plate in the mass to connect electrical ground to the mass and to the heater means mounted in the mass.

The method also includes the step of insert molding at least a portion of the ground plate in the mass.

The apparatus and method for heating fluid and a vehicle surface wash apparatus incorporating a fluid heater according to the present invention affords improvements over previously devised fluid heaters and, in particular, fluid heaters for vehicle wash systems.

The fluid heater of the present invention has secure electrical ground provided to the exterior sheaths of the heater elements by a ground plate which is inserted molded with the heater elements in the mass, with at least a portion of or substantially all of the ground member disposed within the mass by inserting molding with the thermal mass. This eliminates a separate attachment of the ground member to the heater elements as required in previously fluid heater apparatus.

### BRIEF DESCRIPTION OF THE DRAWING

The various features, advantages and other uses of the present invention will become more apparent by referring to the following detail description and drawing in which:

FIG. 1 is a block diagram of a fluid heater apparatus according to the present invention used in an exemplary vehicle window wash fluid delivery system;

FIG. 2 is a perspective view of a heater module or the fluid heater apparatus according to one aspect of the present invention;

FIG. 3 is an exploded perspective view of the heater module shown in FIG. 2;

FIG. 4 is a partially broken away, perspective view of the assembled heater module shown in FIG. 2, oriented with the circuit board upward;

FIG. 5 is a partially broken away, perspective view of the heater module shown in FIG. 2, with the opposite surface oriented upward;

FIG. 6 is a perspective view of the heater module in the orientation of FIG. 5 of the present invention, without the covers and the circuit board;

FIG. 7 is a perspective view of the circuit board side of the heater module, without the covers;

FIG. 8 is a perspective view of the opposite orientation of the heater module shown in FIG. 7;

FIG. 9 is a top perspective view of the heater module thermal mass;

FIG. 10 is a bottom elevational view of the heater module thermal mass shown in FIGS. 6-8;

FIG. 11 is an enlarged plan view of the heater module shown in FIGS. 6-8;

FIG. 12 is a cross-sectional view generally taken along line 12-12 in FIG. 11;

FIG. 13 is a cross-sectional view generally taken along line 13-13 in FIG. 11;

FIG. 14 is a plan view of the freeze protection element shown mounted over the seal on one surface of the thermal conductive;

FIG. 15 is a side elevational view of another aspect of a heater module which an alternate fluid expansion member according to the present invention;

FIG. 16 is a cross-sectional view, generally similar to FIG. 12, but showing another aspect of the present invention;

FIG. 17 is a partially broken away, plan view of a ground terminal connection according to one aspect of the present invention;

FIG. 18 is a partially broken away, plan view of a ground terminal connection according to another aspect of the present invention; and

FIG. 19 is a partially broken away, plan view of a ground terminal connection according to yet another aspect of the present invention.

### DETAILED DESCRIPTION

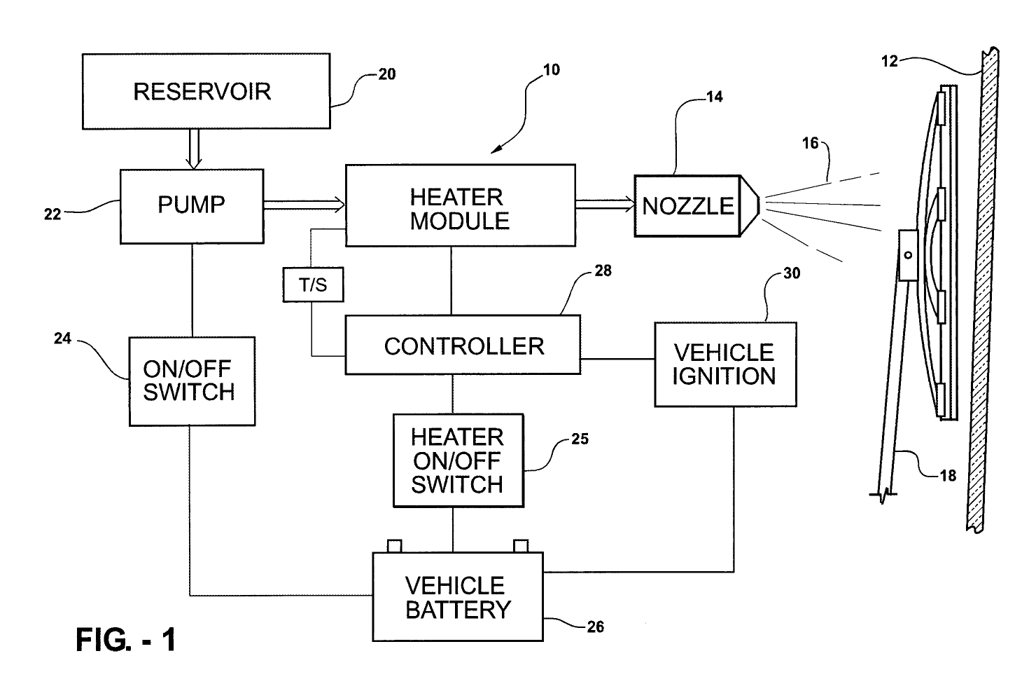

Referring now to FIG. 1, there is depicted an environment in which a heater apparatus or module 10 constructed in accordance with the teachings of the present invention can be advantageously utilized. Although the following use of the heater module 10 of the present invention is described in conjunction with a vehicle window wash system, it will be understood that the present heater module may be employed in other applications requiring heated fluid, such as any cleaning system used to clean any vehicle window, i.e., the windshield, rear backlight, or side windows, as well as cleaning systems for vehicle mirrors, camera, lenses, or sensor covers, etc.

As is conventional, a vehicle window 12, such as a windshield, rear backlight or window, etc., has one or more fluid delivery devices, such as spray nozzles 14 located in a position to dispense or spray a pattern 16 of wash fluid onto the exterior surface of the window 12. The dispersion of the wash fluid 16 is usually in conjunction with activation of a windshield wiper 18 over the window 12.

The wash fluid 16 is supplied from a fluid source, such as a reservoir or container 20. The fluid in the reservoir 20 is pumped to the nozzle(s) 14 by means of a pump 22 usually located in close proximity or attached to the reservoir 20.

As is conventional, an on/off switch 24, which may be mounted on a vehicle steering column stalk switch, is suppled with power from the vehicle battery 26 and enables the vehicle driver to control the on or off operation of the wash pump 22.

According to the invention, the wash fluid pumped from the reservoir 20 to the spray nozzles 14 is heated from ambient temperature to a predetermined higher temperature, such as about 65° C. to about 70° C., by example only, by the heater module 10. A suitable control circuit or controller 28 is provided for controlling the operation of the heater elements in the heater module 10. The controller 28 is also supplied with electric power from the vehicle battery 26. The controller 28 is activated by a “on” signal from the vehicle ignition 30 so as to heat the fluid contained within the flow paths in the heater module 10, as described hereafter, whenever the vehicle ignition is in an “on” state.

An optional on/off switch 25 may be connected between the battery 26 and the controller 28 to provide on and off operation for the entire heater system by disconnecting power to the controller 28. This enables the heater system to be activated or remain in an inactive state at the selection of the vehicle driver. As described hereafter, the on/off switch 25 may also be replaced by a separate input signal to the controller 28 from an external signal source, such as a vehicle body controller, to provide for selective deactivation of the heater module 10 under certain circumstances, such as a thermal event, low battery power, etc.

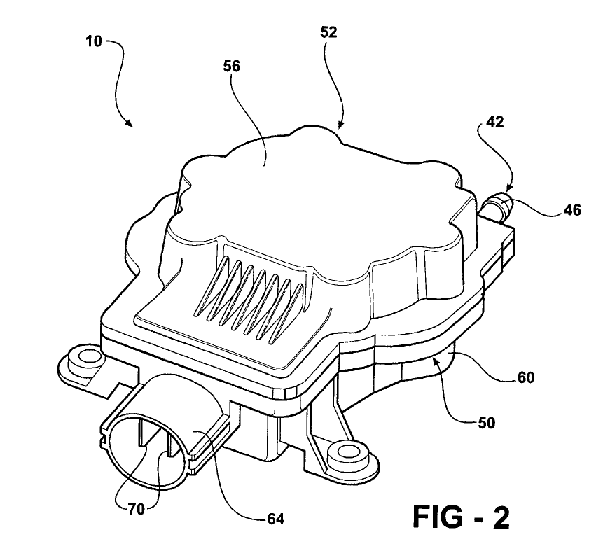

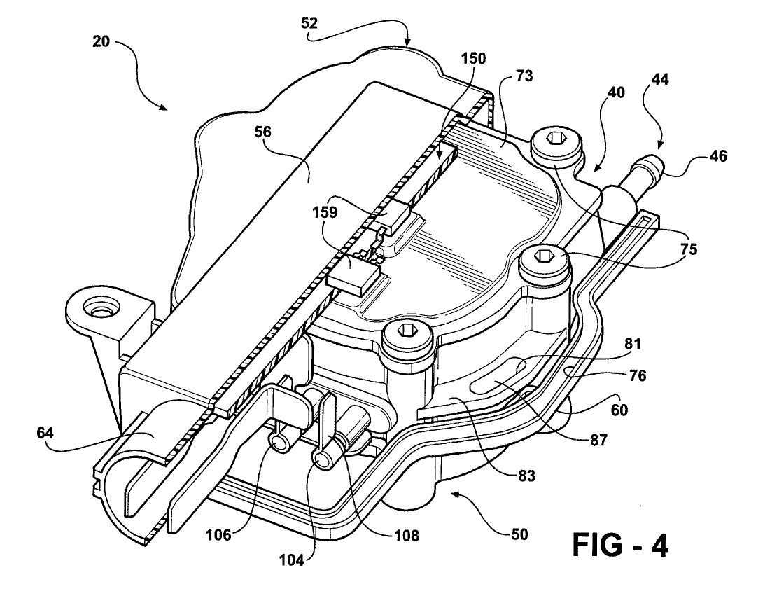

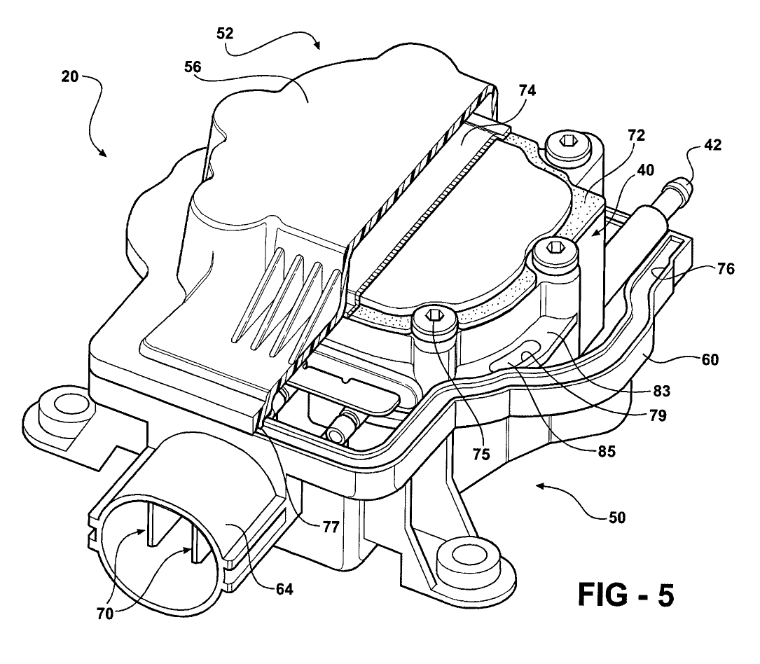

Referring now to FIGS. 2-14, there is depicted one aspect of the heater module 10 according to the present invention.

The heater module 110 includes a heat exchange mass or body 140 formed of a suitable high thermally conductive material. Although the mass 140 is described as being formed of die-cast, molded, or cast or machined aluminum, other materials, either homogenous or nonhomogeneous, may also be employed. For example, the mass 40 can be formed of alumina particles, ceramic materials, etc. The use of molding or casting techniques enables highly thermally conductive and moldable materials to be employed for the thermal mass 140. For example, the mass 40 may be formed of a high thermal conductive ceramic material, such as aluminum oxide, aluminum nitride, boron nitride or magnesium oxide, which can be molded or cast into the shape of the thermal mass 140 described hereafter and shown in FIGS. 2-14. The use of ceramic material forms a compact, dense mass of low porosity which provides the desired high thermal conductivity between the heater elements mounted in the mass, the mass itself and the fluid flowing through the mass.

When a casting process is employed, the heat transfer rate and/thermal conductivity of the material forming the thermal mass 140 can be improved when a solid, low porosity material is utilized. Material processing methods, such as squeeze casting, thixocasting, rhiocasting, machining of a solid mill block, etc., can be advantageously employed since such processing methods remove or minimize the porosity or voids for the final formed mass. This enables the thermal conductivity of the thermal mass 140 to be significantly increase.

The thixocasting and rhiocasting processes as described in U.S. Pat. Nos. 6,311,759; 6,372,063; 6,200,396; 5,968,292; and 5,803,154, byway of example, the contents of which are incorporated herein by reference, generally utilize semi-solid materials where a precursor material of a suitable aluminum or other highly thermally conductive material which has been formed with a gobular a-AL phase and cooled into a slug, is placed in a heating device, heated into the semi-solid region between the solidus and liquidus temperatures and then injected or poured into a casting mold.

The end result of these processes is a dense mass with low porosity or void space. The lower porosity or void space contributes to a higher thermal conductivity since air normally trapped within such voids or interstices reduces the thermal conductivity of the entire mass due to its insulating properties.

For example, the heat transfer rate material effect for a standard casing of 380 aluminum has a thermal conductivity of approximately 96.2 W/m° C. compared to a pored rhiocast or thixocasting with a thermal conductivity of approximately 161 W/m° C. using 356/357 aluminum.

When an application economically allows the use of a more expensive aluminum material, the resulting heat transfer rate material effect of a thixo or rhiocast material can reach approximately 228 W/m° C.

A thermal mass, similar to the thermal mass 140, with a different shape or cross-section can also be formed of various materials, such as aluminum, ceramics and poltruded carbon materials by extrusion.

Regardless of which of the above mentioned materials and processing techniques are used to form the thermal mass 140, the present invention provides a thermal mass 140 with low porosity and low internal void and interstitial spaces thereby providing the thermal mass 140 with a high thermal conductivity for high heat transfer between the heating elements through the thermal mass 140 to the fluid flowing through the channels in the thermal mass, as described hereafter.

The heat exchange mass 40 is disposed within an enclosure or housing formed by a first cover 50 and a second mating cover 52. The first and second covers 50 and 52 have complementary mating edges. The first cover 50 has a major wall surface 54 and a surrounding peripheral lip 60.

The mass 40, as described in greater detail hereafter, includes a fluid flow path between an inlet 42 and an outlet 44. The inlet and outlet 42 and 44, respectively, each receives a fitting 46 for receiving a fluid sealed connection to a fluid flow conduit, element or tube, not shown. The inlet 42 will be connected to receive the pump output from the window wash fluid reservoir 20; while the outlet 44 will be connected to the spray nozzle(s) 14.

As vehicles typically have several spray nozzles 14, usually one for each of the two windshield wipers, and at least one nozzle 14 for the rear backlight or rear window wiper, it will be understood that the following description of a single heater module 10 for heating all of the fluid discharge from the fluid reservoir 20 will encompass multiple parallel paths, each containing a separate heater module, for heating fluid from the reservoir 20 for each different nozzle 14.

The heat exchange mass 40 is disposed within an enclosure or housing formed by a first cover 50 and a second mating cover 52. The first and second covers 50 and 52 have complementary mating edges. The first cover 50 has a major wall surface 54 and a surrounding peripheral lip 60.

A necked-down end portion 64 is formed in the first cover 50, and forms a tubular extension from one portion of the major wall surface 54. The necked-down portion 64 forms an enclosure for receiving a connector assembly 70 which provides electrical signals and power to the heating element(s) mounted in the joined first and second covers 50 and 52 and to a circuit board, described in detail hereafter.

The second cover 52 also has a major wall surface 56 and a surrounding peripheral lip 62 projecting therefrom. The peripheral lip 62 surrounds the entire periphery of the second major wall surface 56.

The first and second covers 50 and 52 are fixedly joined together, after the thermal mass 40 and the connector assembly 70 has been disposed within the first and second covers 50 and 52 by suitable means, such as by heat, sonic or vibration welding. By example, a peripheral groove 76 projects at least partially around the entire edge of the peripheral lip 60. The groove 76 receives a mating projection 77 extending around the peripheral lip 62 of the second cover 52. The projection 77 and groove 76 are fixedly and sealingly joined together by welding to fixedly join the covers 50 and 52 together.

Locating means are provided for locating and fixing the thermal mass 40 to the first and second covers 50 and 52. At least one and preferably a pair of circumferentially spaced slots 79 and 81, are formed on webs 83 extending between two bosses receiving the threaded fasteners on the mass 40. The slots 79 and 81 receive projections 85 and 87 carried on flanges in the first and second covers 50 and 52 at circumferentially spaced locations complementary to the location of the slots 79 81 in the mass 40. The projections 85 and 87 are welded together when the covers 50 and 52 are subjected to a sonic, heat or vibration welding process. In this matter, the thermal mass is fixedly positioned within the covers 50 and 52 when the covers 50 and 52 are themselves joined together.

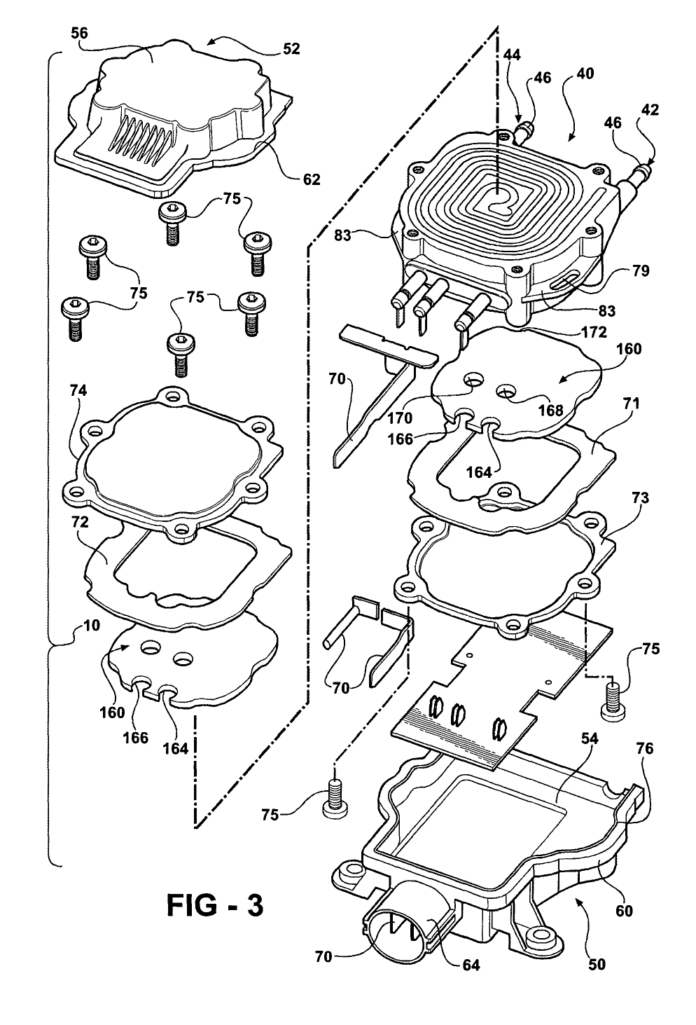

A pair of seal elements 71 and 72, each having a ring shape with another edge substantially the same as the peripheral shape of the heat exchange mass 40 are disposed on opposite surfaces of the heat exchange mass 40 as shown in FIG. 3. The seal members 71 and 72 are formed of a high thermal resistant, insulating material. The seal members 71 and 72 seal the periphery of the heat exchange mass 40.

Upper and lower closures or plates 73 and 74, each also having a shape complimentary to the shape of the heat exchange mass 40, are disposed in contact with the upper and lower seals 71 and 72, respectively, and fixed thereto by suitable fastening means, such as nuts and bolts 75, which extend through apertures in each of the upper and lower plates 73 and 74, and peripherally located bores in heat exchange mass 40. The solid peripheral edges of the plates 73 and 74 and the mating peripheral edges of the heat exchange mass 40 trap the seals 71 and 72 therebetween to seal the joint between the plates 73 and 74 and the mass 40. The upper and lower plates 73 and 74 are formed of a good thermally conductive material, such as aluminum.

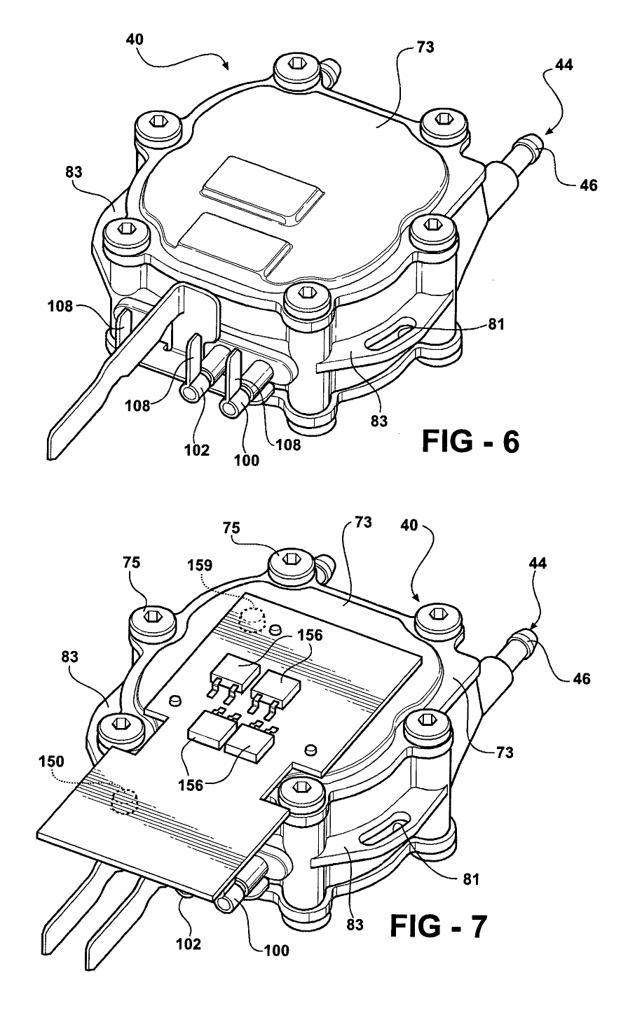

As shown in detail in FIGS. 6-11, the heat exchange mass 40 has a solid cubical shape formed of a first major surface 80, a second opposed major surface 82, and four sidewall portions 84, 86, 88 and 90, interconnecting the first and second surfaces 80 and 82.

A plurality of interior surfaces 92, 94 and 96 are formed in the body 40 and project inwardly from the sidewall 84. The surfaces 92, 94 and 96 each contact one generally cylindrical heater element. As partially shown in FIG. 11, each surface 92, 94 and 96 extends through the solid central portion of the mass 40 so as to be completely surrounded by the solid material of the mass 40. This defines the mass 40 as a heat source after receiving heat from the heater elements contacting each 92, 94 and 96.

In the invention, the heater elements may be formed of “calrod”.

Although different materials may be used, one example of a calrod construction is a Nichrome wire inside of a stainless steel sheath.

By way of example only, at least one and preferably a plurality, i.e., two, more individual heater elements, with three heater elements 100, 102 and 103, depicted by way of example only, are disposed in contact with the surfaces 92, 94 and 96, respectively. The function of the one or more heater elements, such as heater elements 100, 102 and 103 will be described hereafter in conjunction with the operation of the heater module 10.

As described above, the heat exchange or thermal conductive mass 40 can be formed by molding or casting either a flowable or molten material into a suitably formed mold cavity or by the introduction of a metal, such as aluminum, at a semi-solid temperature between the liquidus and solidus temperatures into a mold cavity. Prior to the introduction of the thermal conductive material into the mold cavity, the heater elements 100, 102 and 103 are fixably mounted in the cavity, with an end portion extending outwardly from the mold cavity. The heater elements 100, 102, and 103 are thereby insert molded in the thermal conductive material as a monolithic or unitary part of the 40 when the thermal conductive material solidifies. This places substantially all of the exterior surface of each of the heater elements 100, 102, and 103 in direct contact with the interior surfaces 92, 94, and 96 in the body 40 so as to maximize heat transfer via conduction from the heater elements 100, 102, and 103 to the body 40.

Any air gaps or spaces between the exterior surface of the heater elements 100, 102 and 103 and the adjacent interior surfaces 92, 94 and 96 which could decrease thermal transfer from the heater elements 100, 102 and 103 to the body 40 due to the insulating characteristics of air are minimized or eliminated.

As seen in FIGS. 4 and 7, one end 104, 106 and 107 of each heater element 100, 102 and 103, respectively, projects outwardly through the sidewall 84 of the body 40. The ends 104, 106 and 107 of the heater elements 100, 102 and 103, respectively, each have individual terminals 108 extending therefrom and joined thereto by soldering, welding, etc., for connection to mating sockets or contact spring mounted on a printed circuit board 150, itself mounted by means of fasteners, i.e., screws, rivets, or adhesives, etc., to an exterior surface of the plate 73. Conductive traces in the printed circuit board 150 are connected to sockets or contacts which receive the terminals 108. Two of the connector terminals 70 are soldered to the printed circuit board 150 to receive power, ground and control signals from the vehicle electrical system.

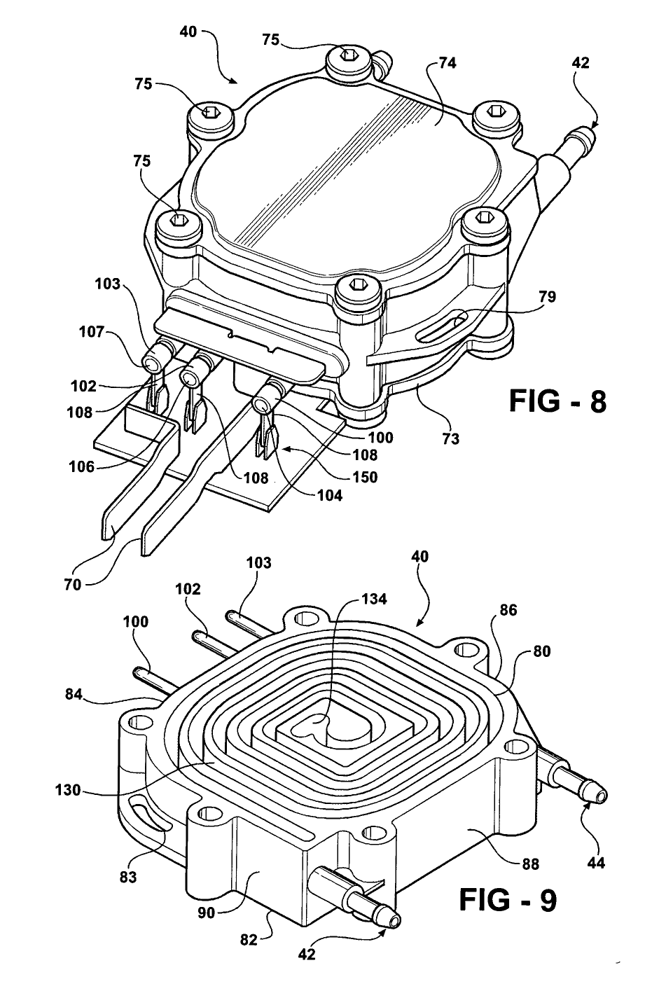

In FIG. 8, a ground terminal or connection is provided for the exterior sheath of the heater elements 100, 102 and 103. One of the terminals 70 includes a depending flange portion of a ground plate which is fixed, such as by welding, to the normally stainless steel exterior sheath of the heater elements 100, 102 and 103. This fastening step normally takes place after the heater elements 100, 102 and 103 are inserted into bores machined in the body 40.

However, in the present invention, since the heater elements 100, 102 and 103 are mounted in the mold cavity prior to the introduction of the flowable material into the cavity used to form the thermally conductive body 40, the ground plate may be prefastened to the heater elements 100, 102 and 103, again by welding, for example, prior to inserting the heater elements 100, 102 and 103 in the mold cavity. The ground plate thus acts as a carrier for the heater elements 100, 102 and 103, and maintains the heater elements 100, 102 and 103 at the desired lateral spacing as well as facilitating mounting of the heater elements 100, 102 and 103 in the mold cavity.

In the aspect of the invention shown in FIG. 8, the ground plate is depicted disposed completely exteriorly of the exterior surface of the body 40.

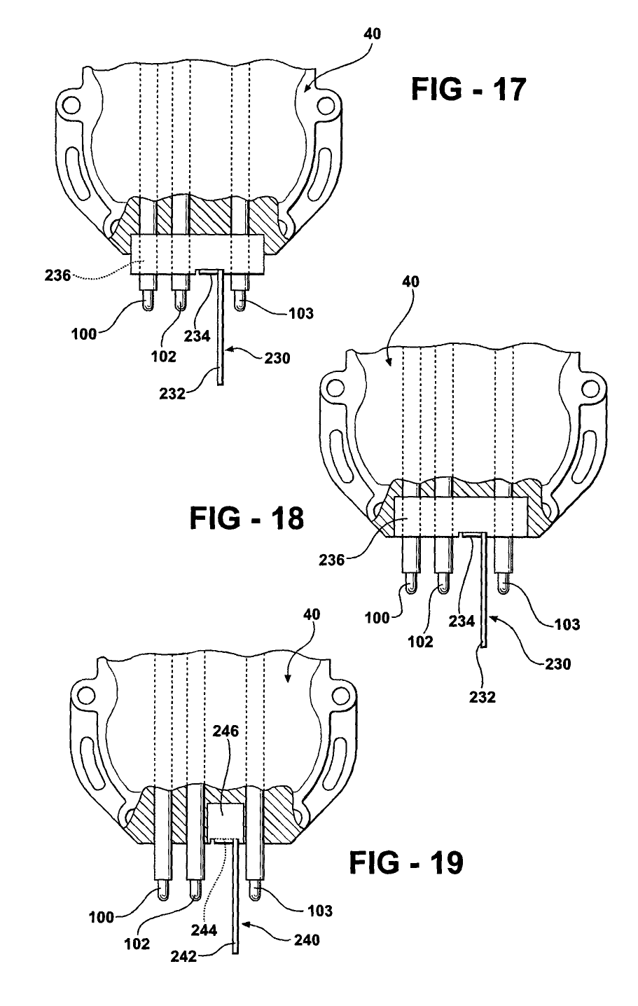

Alternate structural and mounting configurations for the ground terminal are shown in FIGS. 17, 18 and 19.

In FIG. 17, a ground terminal 230 has an exterior leg 232 which extends from a flange 234 projecting from a generally planar plate 236. The plate 236 is fixed, such as by welding, to the metallic outer sheath of the heater elements 100, 102 and 103 prior to placement of the heater elements 100, 102 and 103 in a mold cavity shaped to receive the flowable material used to form the thermally conductive body 40.

In the aspect of the invention shown in FIG. 17, the plate 236 extends partially into the interior of the subsequently formed body 40 and partially exteriorly of the outer surface of the body 40.

Although not as preferred as the one piece terminal 232, flange 234 and plate 236 construction described above, in this aspect of the invention, the connector leg 232 and/or flange 236 may also be formed separately from the plate 236 and fixed thereto, such as by welding, soldering, etc. to the plate 236 after the plate 236 is insert molded in the body 40.

In FIG. 18, the same ground connector 230, is also fixed, such as by welding, to the heater elements 100, 102 and 103 and placed entirely within the mold cavity so as to be completely encompassed by or insert molded to the body 40 after the body 40 solidifies.

Another aspect of a ground terminal connector 240 according to the present invention is shown in FIG. 19. In this aspect, the ground connector 240 also includes a terminal leg 242 which extends from a flange 244 projecting from a generally planar plate 246. The plate 246 and/or the flange 244 are disposed in the mold cavity so as to be substantially entirely encompassed by the body 40 after the body 40 solidifies.

In this aspect, the plate 246 is insert molded to the body 40 and is spaced from and not directly connected to any of the heater elements 100, 102 and 103. Rather, the direct contact between the plate 246, the body 40 and each of the heater elements 100, 102 and 103 insures a solid, continuous ground connection between the ground connector 240 and the exterior sheaths of each of the heater elements 100, 102 and 103 through the body 40.

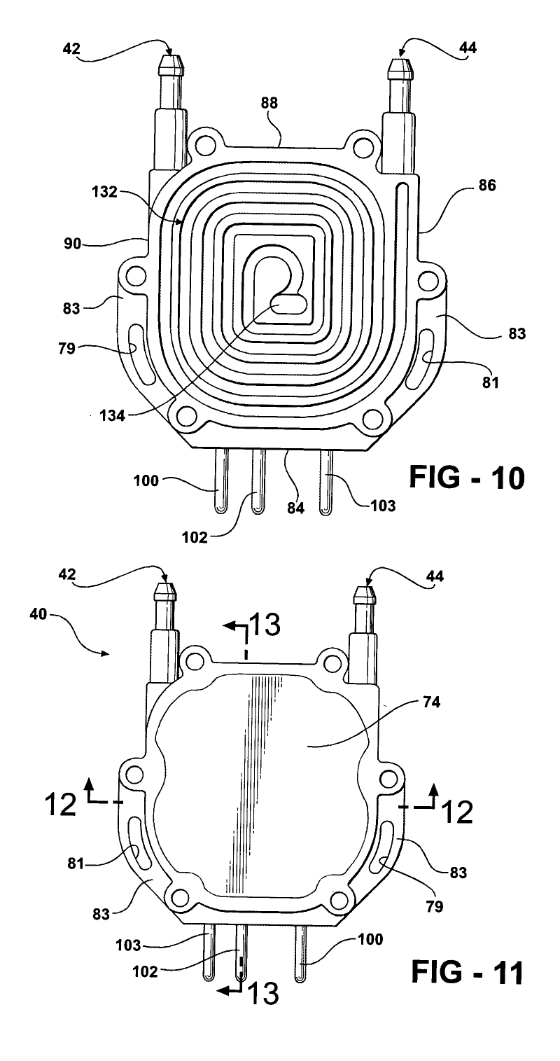

As shown in FIGS. 9 and 10, the thermally conductive mass 40 includes a fluid flow channel or path which extends from the inlet 42 to the outlet 44. The fluid flow path is, by example, a labyrinthian path formed of a first fluid flow path portion 130 and a second fluid flow path or channel 132 which are connected at a generally centrally disposed bore 134. The first fluid flow channel 130 has a generally spiral shape formed of alternating straight and arcuate sections which alternately create laminar and turbulent flow of the fluid passing through the first flow channel 130 to maximize the heat absorption of the fluid from the adjoining walls of the mass 40. Further, the first fluid flow channel 130 has an inward directed spiral shape from the inlet 42 to the bore 134 to minimize temperature differential between adjoining portions of the spiral shaped first flow channel 130.

As shown in FIG. 10, the second fluid flow channel 132 has a substantially identical spiral shape. However, fluid flow through the second fluid flow channel 132 is in an outward spiral direction from the bore 134 to the outlet 44.

Thus, fluid flow through the first and second flow channels 130 and 132 starts from the inlet 44 then continues in a spirally inward directed manner through the first flow channel 130 to the central passage or bore 134. Upon exiting the central passage 134 into the second flow channel 132, fluid flow progresses in an outward spiral direction through the second flow channel 132 to the outlet 44.

In operation, the heater module 40 will be interconnected in the vehicle wash fluid flow lines between the pump 22 and the spray nozzle(s) 14 as shown in FIG. 1. The external connector is then connected to the connector housing 70 to provide electric power from the vehicle battery 26 and the controller 28 to the heater elements 100, 102 and 103, in the heat exchange body 40.

Assuming that the first and second fluid flow channels 130 and 132 in the body 40 are filled with fluid, when the controller 28 activates the heater elements 100, 102 and 103, the heater elements 100, 102 and 103 will begin radiating heat which will immediately raise the temperature of the entire surrounding portion of the heat exchange body 40. Heat from the body 40 will, in turn, be radiated to and absorbed by the fluid disposed in the first and second flow channels 130 and 132.

The straight and arcuate portions of the first and second fluid flow channels 130 and 132 create alternating turbulent and laminar flow regions in the fluid flowing through the mass 40 which causes movement of the fluid in the first and second flow channels 130 and 132 bringing all molecules in the fluid in contact with the wall of the body 40 forming the first and second flow channels 130 and 132 to efficiently absorb the maximum amount of heat possible. This causes the temperature of the fluid to be quickly raised from ambient temperature at the inlet 42 to approximately 160° F.−170° F. at the outlet 44 in approximately sixty seconds.

The fluid in the first and second fluid flow channels 130 and 132 removes or absorbs heat from the thermal mass 40 thereby increasing the fluid temperature by physical contact with the mass 40. The heater elements 100, 102 and 103 maintain the heat of the thermal mass 40 at a predetermined temperature thereby preventing hot spots from occurring in the fluid. Normally, hot spots would occur when the fluid comes in direct contact the heater elements 100, 102 and 103. Fluid which is not in physical contact with the heater elements 100, 102 and 103 passes the heater elements 100, 102 and 103 by and does not absorb heat. By heating the thermal mass 40, the physical hot contact area is increased along with an increase in heat transfer efficiency. This requires less energy to heat the same volume of fluid.

Although a single heater element 100 may be employed as the heat source in the body 40, multiple heater elements, with two or three heater elements, 100, 102 and 103, being described by way of example only, have been found to be most advantageous. The controller 28 can activate all of the plurality of heater elements 100, 102 and 103 upon receiving a first command to dispense heated wash fluid onto the windshield 12. This generates a maximum amount of heat to the body 40 to immediately and quickly raise the temperature of the body 40 high enough to transfer sufficient heat to the fluid in the fluid flow channels 130 and 132 to raise the temperature of the fluid to the desired discharge temperature of about 65° C. to about 70° C. The multiple heater elements 100, 102 and 103 can remain in an activated state by the controller 28 if immediate and successive commands from the on/off switch 24 are supplied by the vehicle driver to supply additional charges of fluid onto the windshield 12.

At the completion of the fluid dispensing operation, and during other periods of non-fluid dispensing while the vehicle engine is running or the engine is running and a dashboard mounted switch, for example, is activated, the controller 28 can cyclically activate one or more of the heater elements, such as heater element 100, to maintain the temperature of the fluid in the first and second flow channels 130 and 132 at an elevated temperature for immediate discharge onto the windshield 12 when activated by the on/off switch 24. This minimizes electrical power requirements on the vehicle battery 26.

Although the controller 28 can provide separate switchable signals to each of the heater elements 100, 102 and 103, in order to control each heater element 100, 102 and 103 separately under program or logic control, one alternate approach includes a bi-metal element or a switch mounted between the power connections to one terminal 108 and each of the other terminals 108 connected to the additional heater elements 102 and 103. The bi-metal element can be set to open at a predetermined temperature, such as 50° C., thereby deactivating the associated heater element. This enables the additional heater elements 102 and 103, for example, to remain deactivated until a high heat requirement is initiated.

Although the following description of the use of high amperage switching devices known as MOSFETs, are used as part of the controller 28 and to provide the necessary high current, typically 50 amps at 12 volts, to the heating elements 100, 102 and 103 in the thermal mass 40, other high amperage switching devices may also be employed. Any number of MOSFETs 156 can be mounted in any configuration on the printed circuit board 150.

A plurality of bores 158 are optionally formed through the printed circuit board 150. The bores 158 improve heat flow between the switching devices on the printed circuit board (PCB) 150 and the underlying first plate 73.

A temperature sensor 159, such as a PTC, is mounted on the printed circuit board 150, typically over or adjacent to the bores 158. The temperature sensor 159 measures the temperature of the printed circuit board 150 and provides a temperature proportional signal to the controller 28 which is used by the controller 28 to control the on/off cycle of the heater elements 100, 102 and 103.

To further enhance transfer of the heat generated by the MOSFETs 156 to the first plate 140, a highly conductive pad or plate 161, hereafter referred to as a sill pad 161, is interposed in contact between the printed circuit board 150 and the first plate 23 as shown in FIGS. 3, 8 and 9. The sill pad 161 typically has a planar shape and dimensions to extend over at least a portion of the first plate 73. The pad 161 isolates stray electrical currents to negative ground through the screws 75, provides a positive contact between the MOSFETs and the thermal mass 40, and stabilizes heat loss through the adjacent cover by maintaining the temperature of the plate 73 at a higher temperature to thereby create a lower temperature differential or gradient with respect to the thermal mass 40.

The sill pad 161 preferably has a higher thermal conductivity than the thermal conductivity of the plate 73 to efficiently draw heat generated by the MOSFETs 156 to the plate 73 thereby maintaining the temperature of the plate 73 at an elevated temperature. This elevated temperature of the plate 73 is higher than the normal temperature of the plate 73 caused by heat escaping from the sides of the thermal mass 40 around the seals 71 and 72.

It is known that during sub-freezing temperatures, wash fluids which are formed substantially of water are subject to freezing. The expansion of the frozen or semi-frozen fluid causes pressure to be exerted against the surrounding components of the heater module 10 which could lead to leaks or to the complete destruction of the heater module 10.

As shown in FIGS. 3, 5 and 11-14, a fluid expansion means 160 is carried in the heater module 10 for reversibly allowing expansion of the fluid in the fluid flow path when the fluid changes phase from a liquid to a substantially solid state. The fluid expansion means, in one aspect of the present invention, is in the form of a thin compressive member such as a generally planar member, formed of a closed cell foam.

One example of a suitable material which could be used to form the fluid expansion means is a closed cell polyolefin foam sold by Voltek, division of Sekisui America Corp., as product number VOLARA type LM. Another possible material is a polyvinyl chloride allied foam, trade name C/3002 or C-2301 from Specialty Composites Division Cabot Safety Corp., Indianapolis, Ind. 46254.

The fluid expansion means 160 has sufficient rigidity under normal fluid operating pressures in the mass 40 to resist compression. The fluid expansion means or member 160 is disposed over an inner edge of each of the seals 71 and 72 on both sides of the thermal mass 30 and has a substantial center portion facing and exposed to the fluid through the open ends of the channels in the thermal mass 40.

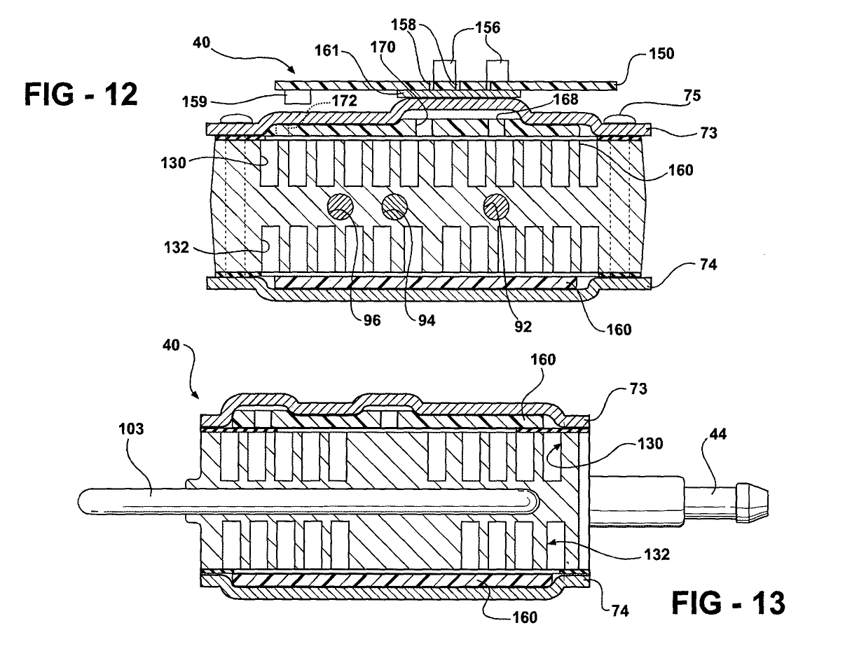

The fluid expansion member 160 has sufficient rigidity to resist expansion or compression under the normal operating pressures of the fluid in the heater module 10. However, at the substantially higher forces exerted by freezing and expansion of the fluid in the channels, the member 160 is capable of compression as shown in phantom in FIGS. 12 and 13 to allow space for the expanded frozen or semi-frozen fluid.

The fluid expansion member 160 has shape memory so as to return to its normally generally planar shape, completely filling an internal cavity 162 formed in an enlarged bulge in each cover 71 and 73.

The fluid expansion member 160 is compressed by the fastening on the plate 73 and 74 to the mass to expand slightly into the channels in the mass 40 and into substantial contact with the surfaces of the thermal mass 40 to close off the open ends of each of the channels in the fluid flow path through the thermal mass 40.

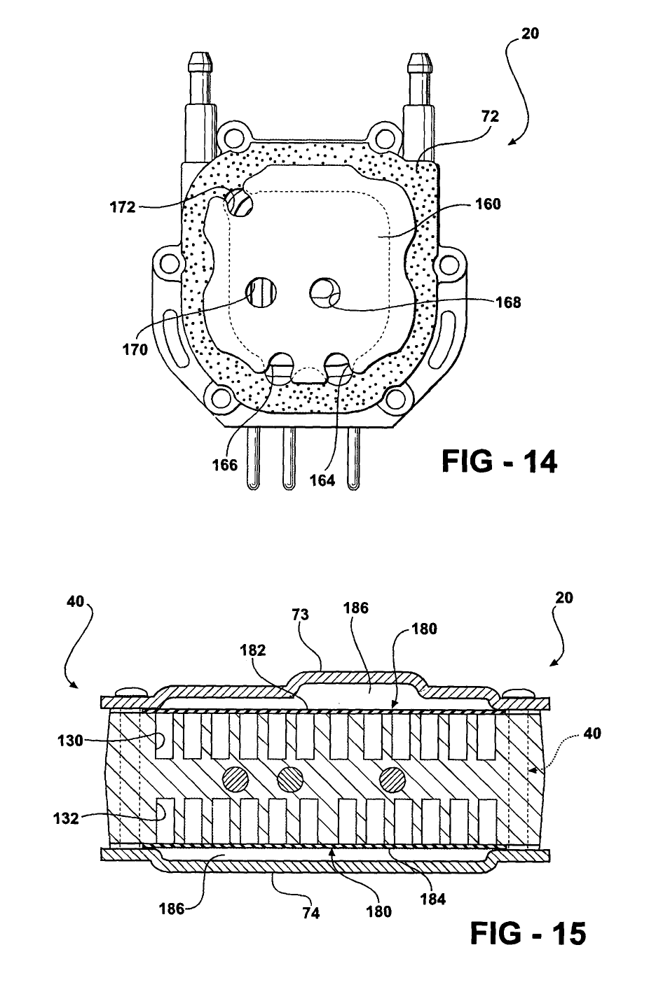

As shown in FIG. 14, the fluid expansion member 160 has additional features to facilitate its use in the heater module 10. A pair of open ended recesses 164 and 166 are formed along one edge of the fluid expansion member 160. The recesses 164 and 166 overlay a portion of the underlying fluid flow channel of the thermal conductive mass 40 to permit a small amount of the fluid in the fluid flow channel to flow through the recesses 164 and 166 against the inside surface of the plate 73 or 74. The high power consuming electronic switching devices, such as the MOSFETs 156, are located immediately opposite an enlargement in the plate 73.

The switching devices 156 are cooled by the flow of water so as to maintain the switching devices 156 at a nominal operating temperature. Additional apertures 168 and 170 are formed in an intermediate portion of the thermal expansion member 160 for a similar purpose to allow fluid flow through the channels in the thermal conductive mass to flow against an inner surface of the adjacent plate 73 to remove heat from the switching devices 156 located immediately there over on the circuit board 150.

An additional open-ended recess 172 is formed on another edge portion of the thermal expansion member 160. The recess 172 underlies the position of the thermal temperature sensor 159 mounted on the circuit board 150. Fluid flow through the recess 172 provides a more accurate temperature measurement by the temperature sensor 159 since it is closer to the fluid flowing through the channels in the thermal mass 40.

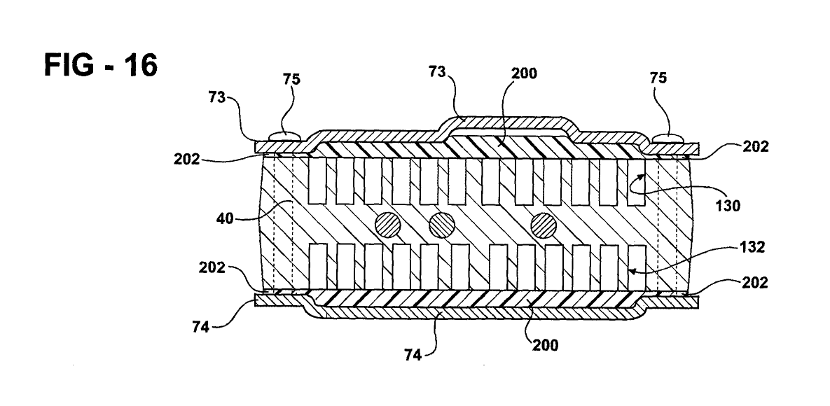

In another aspect of the fluid expansion means 200 shown in FIG. 16, the fluid expansion means 200 is configured to eliminate the seal 71 and 72. The peripheral edge portion 202 of the fluid expansion means or element is compressed when the corresponding plate 73 or 74 is securely fixed to the thermal mass 40 by means of the fasteners 75. Alternately, the peripheral edge portion 202 of the fluid expansion means 200 can be heat and pressure compressed to a smaller thickness than the central portion of the fluid expansion element 200.

In an optional modification shown in FIG. 15, the fluid expansion means 180 is formed by the seal members 182 and 184 having a solid shape over their entire surface area. At least one of the thus formed seal members 182 and 184 is formed with sufficient rigidity to resist expansion when exposed to the normal pressures of fluid flowing through the open ended channels in the thermal mass 40. However, any of the seal members 182 and 184 are capable of expansion into an interior cavity or chamber 186 formed in the enlarged portion of the plate 73 between the seal 182 and the inner surface of the plate 73 to accommodate the expanded frozen or semi-frozen fluid from the mass 40. When the fluid subsequently changes phase back to a liquid state, the seal members 182 and 184 will assume their original shape wherein each of the seal members 182 and 184 is disposed in contact with the open ends of the channels closing off the open end of the channels in the fluid flow path to maintain the desired labyrinthian flow of fluid through the thermal mass 40 as described above.

1. A heater apparatus for heating fluid, the heater apparatus comprising:
a thermally conductive mass;
heating means, disposed in contact with the thermally conductive mass, for imparting heat to the thermally conductive mass;
a fluid flow path formed in the mass between an inlet and an outlet, the fluid flow path coupled in heat transfer relation to the heating means so that fluid in the fluid flow path absorbs heat from the thermally conductive mass, the fluid flow path open to the exterior of the thermally conductive mass; and
an electrical ground member electrically connected to the heating means and to the thermally conductive mass.

2. The heater apparatus of claim 1 wherein:
at least a portion of the electrical ground member is mounted in the mass.

3. The heater apparatus of claim 1 wherein:
at least a portion of the electrical ground member is insert molded in the mass.

4. The heater apparatus of claim 3 wherein:
substantially all of the electrical ground member is disposed within the mass.

5. The heating apparatus of claim 4 wherein:
substantially all of the electrical ground member is insert molded in the mass.

6. The heater apparatus of claim 1 further comprising:
the electrical ground member fixedly mounted at least partially within the mass to establish a common ground between the heating means and the mass.

7. The heater apparatus of claim 1 wherein the fluid flow path comprises:
a first flow path portion extending across one surface of the thermally conductive mass; and
a second flow path portion extending across an opposed surface of the thermally conductive mass, the first and second flow path portions disposed in fluid flow communication.

8. The heater apparatus of claim 7 wherein the first and second flow path portions are disposed in fluid flow communication substantially at the center of the thermally conductive mass.

9. The heater apparatus of claim 1 wherein the heating means comprises:
at least one heater element mounted in the mass.

10. The heater apparatus of claim 9 wherein:
the at least one heater element is in direct contact with the thermally conductive mass over at least a portion of its outer surface.

11. The heater apparatus of claim 1 wherein the heating means comprises:
a plurality of heater elements mounted in the mass.

12. The heater apparatus of claim 10 further comprising: a controller for controlling the activation of each of the heater elements.

13. A method for heating fluid comprising the steps of:
providing a thermally conductive mass having at least one fluid flow path extending therethrough;
disposing a heater means in the thermally conductive mass, with a substantial portion of the heater means in contact with the mass;
fluidically coupling a fluid inlet to one end of the fluid flow path and a fluid outlet to the other end of the fluid flow path wherein fluid in the fluid flow path absorbs heat from the thermally conductive mass, the heat imparted to the mass by the at least one heater element; and
providing an electrical ground member in electrical contact with the thermally conductive mass and the heater means.

14. The method of claim 13 further comprising the steps of:
forming the ground member with a terminal projecting from the mass;
connecting a ground plate connected to the terminal; and
mounting at least a portion of the ground plate in the mass.

15. The method of claim 14 wherein the step of mounting the ground plate in the mass comprises the step of:
insert molding at least a portion of the ground plate in the mass.

16. The method of claim 14 wherein the step of mounting the ground plate in the mass further comprises the step of:
insert molding substantially all of the ground plate in the thermally conducive mass.

17. The method of claim 14 further comprising the step of:
fixedly mounting at least a portion of the ground plate in the mass to connect electrical ground to the mass and through the mass to the heater means mounted in the mass.

18. The method of claim 17 wherein the step of mounting further comprises the step of:
insert molding at least a portion of the ground plate in the mass.

19. A heater apparatus for heating fluid, the heater apparatus comprising:
a thermally conductive mass;
heating means, disposed in contact with the thermally conductive mass, for imparting heat to the thermally conductive mass;
a fluid flow path formed in the mass between an inlet and an outlet, the fluid flow path coupled in heat transfer relation to the heating means so that fluid in the fluid flow path absorbs heat from the thermally conductive mass, the fluid flow path open to the exterior of the thermally conductive mass; and
an electrical ground member electrically connected to the heating means through the thermally conductive mass, the ground member including a plate electrically connected to the thermally conductive mass.

20. The heater apparatus of claim 1 wherein:
the heating means comprises a heater element disposed within an outer metallic sheath; and
the electrical ground member is electrically connected to the outer sheath.
